(19) United States
(12) Patent Application Publication
(10) Pub. No.: US 2007/0049499 A1
(43) Pub. Date: Mar. 1, 2007

(54) Pesticide composition

(75) Inventor: James Patrick Owens, Wyandotte, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation.

(21) Appl. No.: 11/210,383

(22) Filed: Aug. 24, 2005

(51) Int. Cl. A01N 25/04; A01N 25/00; A01N 25/16

(52) U.S. Cl. 504/366; 424/405

(57) ABSTRACT

A pesticide composition includes a pesticide component. The pesticide component is an herbicide and is mixed with water for commercial and residential application. The pesticide composition also includes an alkylphenol ethoxylate surfactant and propylene glycol, which increase the effectiveness of the pesticide component. The pesticide composition further includes a thickener component having a terminal group formed from a 1,2-linear alkyl epoxide having from 16 to 18 carbon atoms. The thickener component includes the reaction product of a combination of ethylene oxide and propylene oxide, 1,1,1-trimethyolpropane, and the 1,2-linear alkyl epoxide. The thickener component modifies rheological properties of the pesticide composition to reduce a tendency of the pesticide composition to disperse when sprayed, to reduce a potential wind-drift of the pesticide composition, to increase a shear viscosity and retention, and to increase a rain fastness of the pesticide composition, resulting in a decrease in costs and potential environmental pollution.

### FIELD OF THE INVENTION

The present invention generally relates to a pesticide composition. More specifically, the present invention relates to a pesticide composition that includes a pesticide component and a thickener component.

### DESCRIPTION OF THE RELATED ART

Use of pesticide compositions is essential in farming and agricultural industries. In these industries, the pesticide compositions reduce a presence of harmful organisms that decrease crop yields and crop quality. However, use of pesticide compositions has disadvantages. A first disadvantage includes wind-drift, i.e., a poor ability to be sprayed onto a target without dispersing, resulting in a decrease in an amount of the pesticide composition reaching the target. A second disadvantage includes a low shear viscosity of the pesticide composition which results in low retention on the target due to a run off of the low viscosity pesticide composition. A third disadvantage includes a likelihood that the pesticide composition may be rinsed off the target due to rain or irrigation. If the pesticide composition is rinsed off of the target, an efficacy of the pesticide composition is reduced. All three disadvantages require additional pesticide composition to be utilized which increases costs and results in potential run-off of the pesticide composition into water sources resulting in possible environmental pollution.

Unsuccessful efforts have been made in the past to eliminate the disadvantages of using the pesticide compositions. One effort is disclosed in U.S. Pat. No. 4,997,471 to Mente, and includes mixing a hydrophobic carbon chain that includes from 1 to 4 carbon atoms with the pesticide composition to thicken the pesticide composition. The '471 patent specifically discloses a pesticide composition that includes a polyoxyalkylene polyether terminated with a compound having from 1 to 4 carbons. The polyoxyalkylene polyether is prepared by reacting ethylene oxide with an initiator that includes from 1 to 18 carbons atoms and active hydrogen atoms. This is followed by reaction with the hydrophobic carbon chain having from 1 to 4 carbons to terminate the polyoxyalkylene polyether. However, the '471 patent does not disclose a pesticide composition including a thickener component having a terminal group formed from an alkyl epoxide having at least 5 carbon atoms. As such, the pesticide composition of the '471 patent has significant wind-drift and an insufficient shear viscosity, which increase a likelihood that the pesticide composition will not be able to be efficiently sprayed onto the target, will disperse when applied, and will not effectively maintain the pesticide composition on the target. Furthermore, the pesticide composition of the '471 patent has an increased likelihood of being rinsed off of the target with rain or irrigation because the pesticide composition does not effectively bind to the target. To compensate for these disadvantages, additional amounts of the pesticide composition must be utilized and consumer costs are increased.

As such, there remains an opportunity for a pesticide composition to be formed that includes a thickener component having a terminal group formed from an alkyl epoxide having at least 5 carbon atoms. The pesticide composition to be formed has consistent and increased shear viscosity, consistent spray characteristics and decreased wind-drift resulting in a reduction of a tendency of the pesticide composition to disperse when sprayed, and a decreased likelihood of being rinsed off of the target.

### SUMMARY OF THE INVENTION AND ADVANTAGES

The present invention provides a pesticide composition. The pesticide composition includes a pesticide component and a thickener component. The thickener component has a terminal group formed from an alkyl epoxide having at least 5 carbon atoms.

The thickener component modifies rheological properties of the pesticide composition. The modified rheological properties reduce a tendency of the pesticide composition to form small droplets and allow for formation of large droplets, when sprayed, and reduce a tendency of the pesticide composition to be subject to wind-drift. The large droplets allow an increased amount of the pesticide composition to reach a target and increase an efficacy of the pesticide composition. The modified Theological properties also increase a shear viscosity of the pesticide composition that impacts on the target. The increased shear viscosity increases a retention of the pesticide composition on the target by 40 to 80% and reduces a possibility that the pesticide composition will run off of the target. The thickener component also increases a rain fastness of the pesticide composition. The increased rain fastness minimizes an amount of the pesticide composition that may be rinsed off of the target with rain or irrigation. Overall, use of the pesticide composition reduces a tendency of the pesticide composition to form small droplets when sprayed, reduces a tendency of the pesticide composition to be subject to wind-drift, increases shear viscosity, and increases retention of the pesticide composition, simultaneously, while decreasing costs and potential environmental pollution.

### DETAILED DESCRIPTION OF THE INVENTION

A pesticide composition is disclosed. The pesticide composition may be applied to a target for the purpose of, but not limited to, preventing, destroying, repelling, regulating, and/or mitigating any pest, and combinations thereof. Any method known in the art may be utilized for applying the pesticide composition to the target. Preferably, the pesticide composition is applied to the target by spraying through a nozzle of a spray applicator. Most preferably, the nozzle of the spray applicator includes, but is not limited to, a D6-45 disc core nozzle and an 8003 flat fan nozzle. One skilled in the art will select an appropriate nozzle based on need and application. The target is not limited and typically includes plants and stationary structures.

The pesticide composition, when sprayed, preferably forms droplets. Preferably, the droplets have a diameter of from 5 to 1,500, more preferably of from 100 to 1,400, and most preferably of from 200 to 1,300, micrometers. The diameter of the droplets allows the pesticide composition to be applied while reducing a tendency of the pesticide composition to be subject to wind-drift. If the pesticide composition has decreased wind-drift, then an increased amount of the pesticide composition will reach the target thereby increasing an efficacy of the pesticide composition.

If the pesticide composition is applied to the target, the pesticide composition preferably has a shear viscosity of at least 5, more preferably of at least 15, and most preferably of at least 40, centipoise at 77° F. The shear viscosity preferably minimizes a molecular break down of the pesticide composition if cycled through a commercial pump and allows the pesticide composition to have a retention of greater than 10, more preferably of from 20 to 100, and most preferably of from 40 to 80, percent at commercial spray conditions well known to those in the art. As used herein, retention is a property of retaining the pesticide composition on the target. The retention reduces a possibility that the pesticide composition will run off of the target thereby increasing an efficacy of the pesticide composition.

The pesticide composition also preferably has excellent rain fastness. Preferably, the pesticide composition, once sprayed onto the target, is not easily rinsed off of the target with rain or irrigation. Without intending to be bound by any particular theory, it is believed that if the pesticide composition is sprayed onto plants, the pesticide composition forms a film, binds to leaves of the plant, and resists being rinsed off of the plant.

The pesticide composition of the present invention includes a pesticide component. The pesticide composition also includes a thickener component having a terminal group formed from an alkyl epoxide having at least 5 carbon atoms, which will be described in greater detail below.

The pesticide component is preferably selected from the group of acaricides, avicides, algicides, biocides, fungicides, herbicides, insecticides, miticides, molluscicides, nematicides, ovicides, rodenticides, virucides, and combinations thereof. More preferably, the pesticide component is selected from the group of fungicides, herbicides, insecticides, and combinations thereof. Most preferably, the pesticide component includes an herbicide and is commercially available from Monsanto Company of St. Louis, Mo., under the trade name of Roundup® Original. The pesticide component may also include, but is not limited to, activators, anti-feedants, anti-fouling agents, anti-microbial agents, attractant agents, bio-pesticides, chemosterilants, disinfectant agents, fumigant agents, microbial pesticides, pheromones, repellent agents, defoliants, desiccants, insect growth regulators, plant growth regulators, repellent agents, synergists, adjuvants, and combinations thereof.

The pesticide component may further include, but is not limited to, acylalanines, acylamino acids, aliphatic amide organothiophosphate, aliphatic nitrogen, aliphatic organothiophosphates, amides, antiauxins, antibiotic, arylalanines, aryloxyphenoxypropionics, auxins, benzamides, benzanilides, benzimidazoles and precursors, benzimidazolylcarbamates, benzofuranyl alkylsulfonates, benzofuranyl methylcarbamate, benzoic acids, benzothiazoles, benzothiopyran organothiophosphates, benzotriazine organothiophosphates, benzoylcyclohexanediones, bipyridyliums, chitin synthesis inhibitors, chloroacetanilides, chloronicotinyl, chloropyridines, chlorotriazines, conazoles, copper, cyclic dithiocarbamates, cyclodienes, cyclohexene oximes, cyclopropylisoxazoles, cytokinins, diacylhydrazines, dichlorophenyl dicarboximides, dimethylcarbamates, dinitroanilines, diphenyl ethers, ethylene releasers, fluorine, furamides, furanilide, gibberellins, growth inhibitors, retardants, and stimulators, halogenated aliphatics, imidazoles, imidazolinones, insect growth regulators, isoindole organothiophosphate, isoxazole organothiophosphate, juvenile hormone and corresponding mimics, mercury, mite growth regulators, morphactins, morpholines, moulting hormones, agonists, and inhibitors, nereistoxins and corresponding analogues, nicotinoids, nitriles, nitroguanidines, nitromethylenes, organomercury, organothiophosphates, oxadiazines, oxathiin, oxazole, oxime organothiophosphate, phenoxys, phenoxyacetics, phenoxybutyrics, phenoxypropionics, phenyl ethylphosphonothioates, phenyl methylcarbamates, phenyl organothiophosphates, phenyl phenylphosphonothioates, phenylenediamines, phenyl pyrazolyl ketones, phenylureas, phosphonothioates, phosphoramidates, phosphoramidothioates, phosphorodiamides, phthalic acids, picolinic acids, polymeric dithiocarbamates, polysulfides, precocenes, pyrazoles, pyrazolopyrimidine organothiophosphate, pyrazolyloxyacetophenone, phenyl pyrazolyl ketones, pyrazolylphenyls, pyrethroids, pyrethroid esters, pyridazines, pyridazinones, pyridylmethylamines, pyrimidinamines, pyrimidines, pyrimidine organothiophosphates, pyrimidinediamines, pyrimidinyloxybenzoic acids, pyrimidinylsulfonylureas, pyrimidinylthiobenzoic acids, quaternary ammoniums, quinolines, quinolinecarboxylic acids, quinones, quinoxalines, strobilurins, sulfite esters, sulfonamides, sulfonanilides, sulfonylureas, tetrazines, tetronic acids, thiadiazole organothiophosphates, thiadiazolylureas, thioamides, thiazoles, thiocarbamates, thiocarbonates, thiophenes, thioureas, triazines, triazinones, triazinylsulfonylureas, triazoles, triazole organothiophosphates, triazolones, triazolopyrimidines, uracils, ureas, valinamides, xylylalanines, combinations thereof, and salts thereof including but not limited to, alkaline and alkaline earth metal salts, trimesium salts, ammonium salts, isopropylamine salts, and combinations thereof.

The pesticide component may be present in the pesticide composition in any amount, dependent on requirements of the United States Environmental Protection Agency. In one embodiment of the present invention, the pesticide composition is a concentrate. In this embodiment, the concentrate may include water, oil, and combinations thereof, and may include an emulsion of water and oil. Preferably, the concentrate is diluted with water prior to application. In this embodiment, the pesticide component is diluted and preferably present in the pesticide composition in an amount of at least 1 part by weight per 100 parts by weight of water. More preferably, the pesticide component is diluted and present in an amount of from 1 to 10, even more preferably of from 3 to 7, and most preferably of 5, parts by weight per 100 parts by weight of the water. In another embodiment, the pesticide component is not diluted with water. If the pesticide component is not diluted with water, the pesticide component is present in the pesticide composition in an amount of from 1 to 100, more preferably of from 3 to 7, and most preferably of 5, parts by weight per 100 parts by weight of the pesticide composition. It is to be appreciated that one skilled in the art will choose whether to mix the pesticide component with water, depending on application.

Referring now to the thickener component first introduced above, the thickener component preferably includes the reaction product of an alkylene oxide, a compound having at least two active hydrogen atoms, and the alkyl epoxide. More preferably, the alkylene oxide and the compound react together before any reaction with the alkyl epoxide. The alkylene oxide may be any alkylene oxide known in the art. The alkylene oxide is preferably selected from the group of ethylene oxide, propylene oxide, butylene oxide, amylene oxide, and combinations thereof. More preferably, the alkylene oxide is selected from the group of ethylene oxide, propylene oxide, and combinations thereof. Other suitable alkylene oxides include, but are not limited to, tetrahydrofuran, alkylene oxide-tetrahydrofuran mixtures, epihalohydrins, aralkylene oxides, and combinations thereof.

The compound may be any known in the art and includes at least two reactive hydrogen atoms. The reactive hydrogen atoms are typically a member of a functional group including, but not limited to, an oxygen atom such as a hydroxyl, a phenol, and a carboxylic acid group, a basic nitrogen atom such as an amine, a hydrazine, an imine, an amide, a guanidine, a sulfonamide, a urea, and a thiourea group, and a sulfur atom such as a mercaptan, a thiphenol, a thiocarboxylic, and a hydrogen sulfide group. Alternatively, the reactive hydrogen atoms may be in close proximity to carbonyl groups such as those included in cyanoacetic esters, acetoacetic esters, and malonic esters.

Preferably the compound is selected from the group of glycerol, 1,1,1-trimethylolpropane, and combinations thereof. Most preferably, the compound includes 1,1,1-trimethylolpropane. Examples of other suitable compounds include, but are not limited to, alkane polyols, alkene polyols, alkyne polyols, aromatic polyols, oxyalkylene polyols, oxalic acid, mono-, di-, and tri-ethanolamine, butylamine, aniline, resorcinol, diethylmalonate, diethylmaleate, ethylene diamine, bisphenol A, hydroquinone, and combinations thereof. Examples of suitable alkane polyols include, but are not limited to, ethylene glycol, propylene glycol, 1,4-butanediol, 1,2-butanediol, diethylene glycol, polyethylene glycol, trimethyolethane, 2,3,5,6-hexane tetrol, sorbitol, pentaerythritol, glucose, sucrose, and combinations thereof. Examples of suitable alkene polyols include, but are not limited to, 2-butene-1,4-diol, 2-hexene-1,4,6-triol, 3-heptene-1,2,6,7-tetrol, 1,5-hexadiene-3,4-diol, and combinations thereof. Examples of suitable alkyne polyols include, but are not limited to, 2-butyne-1,4-diol, 2-hexyne-1,4,6-triol, 4-octyne-1,2,7,8-tetrol, and combinations thereof. Example of oxyalkylene polyols include, but are not limited to, diethylene glycol, triethylene glycol, tetraethylene glycol, propylene glycol, dipropylene glycol, tripropylene glycol, and combinations thereof. Preferably the compound has of from 2 to 10, more preferably of from 2 to 6, and most preferably of from 2 to 4, carbon atoms.

The compound and the alkylene oxide preferably react to form a polyol. In one embodiment of the present invention, the alkylene oxide reacts with the compound to form the polyol directly. In this embodiment, the alkylene oxide is preferably reacted in an amount such that the polyol will include of from 98.5 to 99.6, more preferably of from 98.7 to 99.5, and most preferably of from 99.1 to 99.3 parts by weight of the alkylene oxide per 100 parts by weight of the polyol. Preferably, the alkylene oxide reacts with the compound at a temperature of from 50 to 150 and more preferably of from 80 to 130, °C. and at a pressure of from 70 to 100, and more preferably of from 80 to 90, psig.

In another embodiment, the alkylene oxide includes a first combination of ethylene oxide and propylene oxide and reacts with the compound to form an intermediate. To form the intermediate, the alkylene oxide is preferably reacted in an amount such that the intermediate will include of from 73 to 91, more preferably of from 77.5 to 89.2, and most preferably of from 82 to 85 percent by weight of the alkylene oxide per 100 parts by weight of the intermediate. More specifically, the intermediate will preferably include of from 65 to 85, more preferably of from 70 to 80, and most preferably of from 73 to 77, parts by weight of ethylene oxide per 100 parts by weight of the intermediate. Also more specifically, the intermediate will preferably include of from 15 to 35, more preferably of from 20 to 30, and most preferably of from 23 to 27, parts by weight of propylene oxide per 100 parts by weight of the intermediate. Preferably, the alkylene oxide reacts with the compound at a temperature of from 50 to 150 and more preferably of from 80 to 130, °C. and at a pressure of from 70 to 100, and more preferably of from 80 to 90, psig.

After the intermediate is formed, the intermediate preferably reacts with additional alkylene oxide to form the polyol. In this embodiment, the additional alkylene oxide preferably includes a second combination of the ethylene oxide and the propylene oxide. The second combination may be the same as the first combination or may be different. The alkylene oxide is preferably reacted in an amount such that the polyol will include of from 98.7 to 99.6, more preferably of from 98.9 to 99.5, and most preferably of from 99.1 to 99.3 percent by weight of the alkylene oxide per 100 parts by weight of the polyol. More specifically, the polyol will preferably include of from 70 to 100, more preferably of from 80 to 95, and most preferably of from 85 to 89, parts by weight of ethylene oxide per 100 parts by weight of the polyol. Also more specifically, the polyol will preferably include less than or equal to 30, more preferably of from 5 to 15, and most preferably of from 11 to 15, parts by weight of propylene oxide per 100 parts by weight of the polyol. Preferably, the alkylene oxide reacts with the intermediate at a temperature of from 50 to 150 and more preferably of from 80 to 130, °C. and at a pressure of from 70 to 100, and more preferably of from 80 to 90, psig. The polyol may have any molecular weight. However, the polyol preferably has a molecular weight of from 10,000 to 30,000, more preferably of from 12,000 to 25,000, and most preferably of from 15,000 to 18,000, g/mol.

Additionally, the polyol may be formed in the presence of a catalyst. The catalyst may include a single catalyst, a plurality of catalysts, or a combination of catalysts, and may be any catalyst known in the art. In one embodiment, the catalyst includes a polymerization catalyst, which catalyzes a reaction of the alkylene oxide and the compound. Particularly suitable polymerization catalysts include, but are not limited to, potassium hydroxide, cesium hydroxide, and combinations thereof. The polymerization catalyst may be added to the alkylene oxide and/or compound in any amount. Preferably, the polymerization catalyst is added in an amount of from 0.1 to 5, more preferably of from 0.3 to 1, and most preferably of from 0.5 to 0.7, parts by weight per 1000 parts by weight of the compound.

In another embodiment, the catalyst may include an alkaline oxyalkylation catalyst. Suitable examples of alkaline oxyalkylation catalysts include, but are not limited to, alkaline and alkaline earth metal hydroxides and alkylates, such as lithium, sodium, potassium, rubidium, beryllium, magnesium, calcium, and strontium hydroxides and methylates, salts of strong bases with weak acids such as alkaline and alkaline earth acetates and glycolates, quaternary ammonium compounds such as benzyl dimethyl cetyl ammonium compounds, and combinations thereof. If the catalyst includes the alkaline oxyalkylation catalyst, the catalyst is preferably present in an amount of from 0.1 to 5, more preferably of from 0.3 to 1, and most preferably of from 0.5 to 0.7, parts by weight per 1000 parts by weight of the compound.

The alkylene oxide may also react with the compound and/or intermediate in a solvent. Any solvent known in the art may be used. The solvent preferably includes an inert organic solvent. More preferably, the solvent includes, but is not limited to, aliphatic hydrocarbons such as hexane, heptane, and isoheptane, aromatic hydrocarbons such as benzene, toluene, and xylene, chlorinated hydrocarbons such as carbon tetrachloride, ethylene dichloride, and propylene dichloride, and oxygenated hydrocarbons such as diethyl ether, dimethyl ether, anisole, and combinations thereof. Preferably, the solvent is included in an amount sufficient to provide a suitable reaction medium and is typically present in excess of a total amount of the alkylene oxide and the compound and/or intermediate, on a mole basis.

After the alkylene oxide reacts with the compound to form the polyol, the polyol preferably reacts with the alkyl epoxide to form the thickener component. The alkyl epoxide has at least 5 carbons atoms. Any alkyl epoxide known in the art having at least 5 carbon atoms may be utilized in the present invention. Preferably, the alkyl epoxide has of from 8 to 28, more preferably of from 8 to 18, and most preferably of from 16 to 18 carbon atoms. Preferably, the alkyl epoxide is a linear alkyl epoxide. Most preferably, the alkyl epoxide is a 1,2-linear alkyl epoxide. For descriptive purposes only, the 1,2-linear alkyl epoxide preferably includes the general structure: 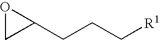
wherein R¹ includes one of an alkyl group, an aromatic group, a hydrogen, and any compound including combinations thereof. Examples of suitable 1,2-linear alkyl epoxides include, but are not limited to the following structures: 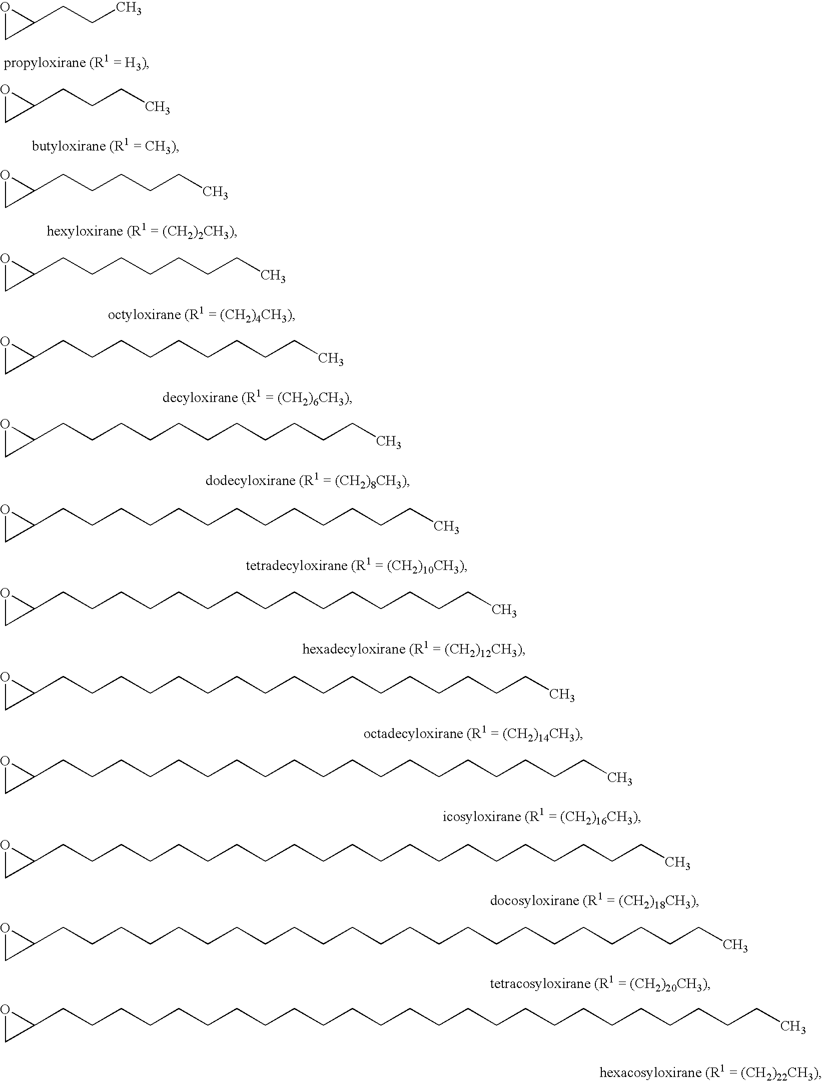
and combinations thereof. Most preferably, the 1,2-linear alkyl epoxide is commercially available from Atofina Corporation, under the trade name of Vikolox®. Preferably, the alkyl epoxide reacts with the polyol in an amount of from 0.5 to 20, more preferably of from 1 to 15, and most preferably of from 1.5 to 6, moles per one mole of the polyol. Preferably, the alkyl epoxide reacts with the polyol at a temperature of from 50 to 150° C., more preferably of from 80 to 130° C., and most preferably of from 115 to 125° C., under a padding of inert gas.

Without intending to be limited by any particular theory, it is believed that if the alkyl epoxide reacts with the polyol, the polyol initiates a nucleophilic ring opening of the alkyl epoxide such that the alkyl epoxide caps the polyol with a hydrophobic terminal group, thereby forming the thickener component. However, the polyol may copolymerize with the alkyl epoxide to produce a heteric polyol.

Preferably, the thickener component has a molecular weight of from 1,000 to 75,000, more preferably of from 1,000 to 40,000, and most preferably of from 15,000 to 18,000, g/mol. Also, the thickener component is preferably present in the pesticide composition in an amount of from 0.01 to 10, more preferably of from 0.1 to 8, and most preferably of from 0.3 to 3, parts by weight per 100 parts by weight of the diluted pesticide composition. For descriptive purposes only, a chemical reaction schematic of the reaction of the polyol and the alkyl epoxide to form the thickener component is illustrated below, wherein AO is the alkylene oxide and R¹ includes one of the alkyl group, the aromatic group, the hydrogen, and any compound including combinations thereof, and m includes an integer.

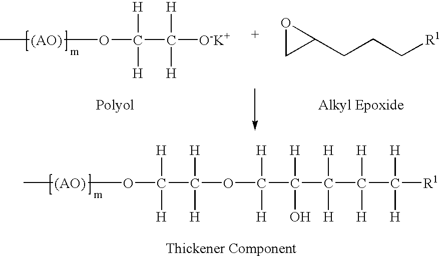

In one embodiment of the present invention, the polyol may react with the alkyl epoxide and a second alkyl epoxide, having at least 5 carbon atoms, to form the thickener component. The second alkyl epoxide may be the same as the alkyl epoxide or may be different. Most preferably, the second alkyl epoxide is the same as the alkyl epoxide. If the polyol reacts with the alkyl epoxide and the second alkyl epoxide, it is believed that the polyol initiates the nucleophilic ring opening of the alkyl epoxide capping the polyol with the hydrophobic terminal group. It is also believed that a secondary hydroxyl group on the alkyl epoxide is allowed to attack the second alkyl epoxide in a second nucleophilic ring opening. If this occurs, it is believed that the second alkyl epoxide also caps the polyol such that the polyol is “double capped,” thereby forming the thickener component. However, the polyol may copolymerize with the alkyl epoxide and the second alkyl epoxide to produce a heteric polyol. For descriptive purposes only, a chemical reaction schematic of the reaction of the polyol, the alkyl epoxide, and the second alkyl epoxide, to form the thickener component is illustrated below, wherein AO is the alkylene oxide and R¹ includes one of the alkyl group, the aromatic group, the hydrogen, and any compound including combinations thereof, and m includes an integer.

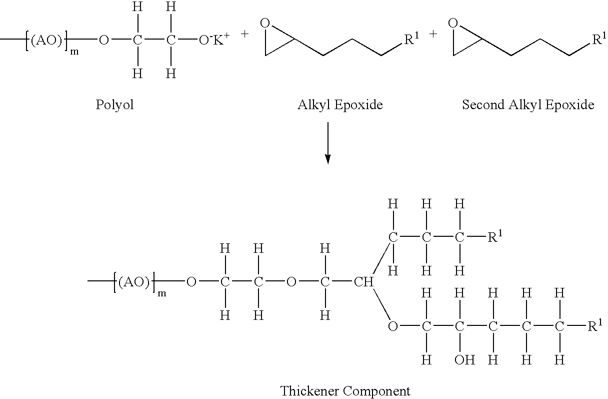

Additionally, the alkyl epoxide may react with the polyol in the presence of a second catalyst. The second catalyst may be the same as the catalyst, or may be different. Preferably, the second catalyst includes, but is not limited to, potassium hydroxide, cesium hydroxide, and combinations thereof.

Referring now to the pesticide composition, the pesticide composition may also include an additive selected from the group of a water soluble amine, water, alcohol, and combinations thereof. One or a plurality of additives may be utilized in the present invention, and the additive may be present in the pesticide composition in any amount. In one embodiment, the additive includes the water soluble amine. Any water soluble amine known in the art may be used in the present invention. Preferably, the water soluble amine includes, but is not limited to, aromatic and cyclo-aliphatic amines including alkanol amines, methylamine, dimethylamine, trimethylamine, ethylamine, diethylamine, triethylamine, n-propylamine, di-n-propylamine, tri-n-propylamine, isopropylamine, n-butylamine, isobutylamine, secondary butylamine, tertiary butylamine, cyclohexylamine, benzylamine, alpha-phenylethylamine, beta-phenylethylamine, ethylenediamine, tetramethylenediamine, hexamethylenediamine, tetramethylammonium hydroxide, morpholine, N-methyl morpholine, N-ethyl morpholine, dimethylaminopropylamine, N,N-dimethylethanolamine, alpha- and gammapicoline, piperazine, isopropylaminoethanol, N,N-dimethylcyclohexylamine, 2-amino-2-methyl-1-propanol, and combinations thereof.

In another embodiment of the present invention, the additive includes the alcohol. Preferably, the alcohol includes propylene glycol. However, any alcohol known in the art may be used. If the propylene glycol is included in the pesticide composition, the propylene glycol preferably allows the pesticide composition to be easily pourable.

Other additives that may be present in the pesticide composition include, but are not limited to, spreading agents, wetting agents, building agents, extending agents, emulsifiers, dispersants, suspending agents, plant penetrants, translocators, oils, activators, foliar nutrients, compatibility agents, drift retardants, foam retardants, buffers, inverting agents, soil penetrants, stabilizing agents, UV filters, feeding stimulants, washing agents, sinking agents, binders, liquid carriers, dry carriers such as attapulgite, kaolinite, vermiculite, starch polymers, corn cob, and combinations thereof. The other additives may be present in the pesticide composition in any amount.

The pesticide composition may also include a surfactant. Surfactants typically modify surface properties of the pesticide composition. Preferably the surfactant contributes to efficacy of the pesticide composition through increased activity and increased damage to the pest. The surfactant may be any surfactant known in the art, including, but not limited to, anionic, cationic, amphoteric, and non-ionic surfactants, carboxylic acid surfactants, sulfate surfactants, sulfonic acid surfactants, phosphate surfactants, polyoxyalkylene polyol surfactants, alkylphenol ethoxylate surfactants, and combinations thereof. Other suitable surfactants include, but are not limited to, copolymers of acrylic acid and vinyl acetate, copolymers of acrylic acid and maleic acid, N-methyl-(C₁₂-C₁₈) fatty acid sarcosinates, resin acids, (C₁₂-C₁₈) fatty acids, salts of the carboxylic acids, and combinations thereof. Suitable sulfate surfactants include, but are not limited to, (C₁₂-C₁₈) alkyl sulfates, polyoxyethylene (C₁₂-C₁₈) alkyl ether sulfates, polyoxyethylene (mono or di) (C₈-C₁₂) alkylphenyl ether sulfates, sulfates of polymers of polyoxyethylene (mono or di) (C₈-C₁₂) alkyliphenyl ethers, polyoxyethylene (mono, di or tri)phenylphenyl ether sulfates, polyoxyethylene (mono, di or tri)benzylphenyl ether sulfates, polyoxyethylene (mono, di or tri)styrylphenyl ether sulfates, sulfates of polymers of polyoxyethylene (mono, di or tri)styxylphenyl ethers, sulfates of polyoxyethylene-polyoxypropylene block polymers, sulfated oils, sulfated fatty acid esters, sulfated fatty acids, sulfated olefins, salts of the sulfate surfactants, and combinations thereof. Suitable sulfonic acid surfactants include, but are not limited to, (C₁₂-C₂₂) paraffinsulfonic acids, (C₈-C₁₂) alkylbentenesulfonic acids, formalin condensates with (C₈-C₁₂) alkylbenzenesulfonic acids, formalin condensates with cresolsulfonic acids, (C₁₄-C₁₆) a-olefmsulfonic acids, (C₈-C₁₂) dialkyl sulfosuccinic acids, lignin sulfonic acids, polyoxyethylene (mono or di) (C8-C₁₂) alkylphenyl ether sulfonic acids, half esters of polyoxyethylene (C₈-C₁₂) alkyl ether sulfosuccinic acids, naphthalenesulfonic acids, (mono or di) (C₁-C₆) alkylnaphthalenesulfonic acids, formalin condensates with naphthalenesulfonic acids, formalin condensates with (mono or di) (C₁-C₆) alkylnaphthalenesulfonic acids, formalin condensates with creosote oil sulfonic acids, (C₈-C₁₂) alkyldiphenyl ether disulfonic acids, Igepon T, polystyrenesulfonic acids, copolymers of styrenesulfonic acid and methacrylic acid, salts of the sulfonic acid surfactants, and combinations thereof. Examples of suitable phosphate surfactants include, but are not limited to, (C₈-C₁₂) alkyl phosphates, polyoxyethylene (C₁₂-C₁₈) alkyl ether phosphates, polyoxyethylene (mono or di) (C₈-C₁₂) alkylphenyl ether phosphates, phosphates of polymers of polyoxyethylene (mono, di or tri) (C₈-C₁₂) alkylphenyl ethers, polyoxyethylene (mono, di or tri)phenylphenyl ether phosphates, polyoxyethylene (mono, di or tri)benzylphenyl ether phosphates, polyoxyethylene (mono, di or tri)styrylphenyl ether phosphates, phosphates of polymers of polyoxyethylene (mono, di or tri)styrylphenyl ethers, phosphates of polyoxyethylene-polyoxypropylene block polymers, phosphatidyl cholines, phosphatidyl ethanolimines, polyphosphates (e.g., tripolyphosphate, etc.), salts of the phosphate surfactants, and combinations thereof. Suitable examples of the polyoxyalkylene polyol surfactants, include, but are not limited to Pluronic® polyethers and Tetronic® polyethers, commercially available from BASF Corporation of Wyandotte, Mich. Suitable examples of the alkylphenol ethoxylate surfactants include, but are not limited to, Iconol® and Lutensol® surfactants, commercially available from BASF Corporation of Wyandotte, Mich., and BASF Aktiengesellschaft of Ludwigshafen, Germany, respectively. Specifically, salts of the carboxylic acid, sulfonic, sulfate, phosphate, and polyoxyalkylene, and alkylphenol ethoxylate surfactants, include, but are not limited to, alkaline and alkaline earth metal salts, ammonium and amine salts, and combinations thereof. Most preferably, the surfactant includes Lutensol® AO 8, Iconol® 35-8, and combinations thereof. If the pesticide composition includes the surfactant, the surfactant is preferably included in an amount of from 0.01 to 10, more preferably of from 0.01 to 8, and most preferably of from 0.3 to 3, parts by weight per 100 parts by weight of the pesticide composition. In one embodiment of the present invention, the pesticide composition includes the thickener component, the Iconol® 35-8 as the surfactant and propylene glycol as the additive in a 1:1:1 ratio.

### EXAMPLES

A series of pesticide compositions, Compositions 1 through 14, are formulated according to the present invention. A series of comparative pesticide compositions, Comparative Compositions 1 and 2, are also formulated but do not include the pesticide composition of the present invention. A spray particle size distribution is measured for the Compositions 1 through 14 and the Comparative Compositions 1 and 2. The Compositions 1 through 14 and the Comparative Compositions 1 and 2 are sprayed through either a flat fan nozzle (8003) or a disc-core nozzle (D6-45), to form a plume of droplets, under simulated ground spray application in a wind tunnel.

Specifically, each of the Compositions 1 through 14 and the Comparative Compositions 1 and 2 are formulated by adding 5 parts by weight of a pesticide as a concentrate to 100 parts by weight of tap water, in separate 5 gallon containers. Additionally, for each of the Compositions 1 through 14, varying amounts of a thickener component and surfactant of the present invention are added.

After the thickener component and surfactant are added, the Compositions 1 through 14 and the Comparative Compositions 1 and 2 are mixed and subsequently transferred to separate pressurized containers fluidly connected to either the flat fan nozzle or the disc-core nozzle, and to a source of pressurized air used to displace the Compositions 1 through 14 and the Comparative Compositions 1 and 2 through the nozzles. Each of the pressurized containers is inverted several times to ensure adequate mixing the Compositions 1 through 14 and the Comparative Compositions 1 and 2. After inversion, each of the Compositions 1 through 14 and the Comparative Compositions 1 and 2 are pumped through either the flat fan nozzle or the disc-core nozzle using a commercial pump typical of a pump used for ground spraying. The Compositions 1 through 14 and the Comparative Compositions 1 and 2 are sprayed at a 0° spray angle compared to the wind tunnel at 1.7 bar and are subjected to a varied number of passes through the commercial pump.

As the Compositions 1 through 14 and the Comparative Compositions 1 and 2 are sprayed, a Malvern laser diffraction particle size analyzer is utilized to characterize a droplet diameter for each of the compositions. The droplet diameter is measured using an 800 mm focal length lens which measures the droplet diameter in a range of from 4 to 1504 μm. Specifically, the droplets formed by the nozzles are not spatially uniform. A diameter of the droplets varies in the plume with the droplets having a larger diameter present at the edge of the plume and the droplets having a smaller diameter present at the center of the plume. As such, a cross-sectional average is obtained by traversing the nozzles vertically across the laser while sampling. The diameter of the droplets is calculated by the particle size analyzer according to ASTM E799-87.

A Volume Median Diameter (D_{V0.5}) of the droplets is also determined. The Volume Median Diameter is the diameter of the droplets at which 50% of a total volume of the spray is included within the droplets with the larger and smaller diameters. A volume percentage of droplets with diameters of less than 141 μm is also measured because this falls within a range known in the art of less than 100-200 μm that is believed to be prone to increased wind-drift. Further, a decrease in cumulative volume percentages of droplets, relative to the Comparative Compositions 1 and 2, of varying diameters of the Compositions 1 through 14 and Comparative Compositions 1 and 2 are also determined. The decrease in the cumulative volume percentages of the droplets of the Compositions 1 through 14 are set forth in Table 1 as normalized to the volume percentages of the droplets of the Comparative Compositions 1 and 2. The results of the spray particle size distribution including the Volume Median Diameter and the Volume Percentage are also set forth in Table 1, wherein all components are in parts per one hundred parts water unless otherwise noted.

TABLE 1

| | Comparative | Comparative | | |
|---|---|---|---|---|
| Component | Composition 1 | Composition 2 | Composition 1 | Composition 2 |
| Pesticide | 5 | 5 | 5 | 5 |
| Concentration | | | | |
| Concentration | 0 | 0 | 0.8 | 0.8 |
| of Thickener | | | | |
| Component 1 | | | | |
| Concentration | 0 | 0 | 0 | 0 |
| of Thickener | | | | |
| Component 2 | | | | |
| Number of | 0 | 0 | 0 | 6 |
| Recirculations | | | | |
| Through Pump | | | | |
| Surfactant 1 | 0 | 0 | 0.8 | 0.8 |
| Nozzle Type | D6-45 | 8003 | D6-45 | D6-45 |
| Volume Median | 288.3 | 270.3 | 311.3 | 316 |
| Diameter (μm) | | | | |
| Volume | 14.9 | 15.0 | 13.4 | 13.6 |
| Percentage of | | | | |
| Droplets With | | | | |
| Diameters Less | | | | |
| Than 141 μm | | | | |
| Decrease in | 0.0 | 0.0 | −0.4 | 2.3 |
| Cumulative | | | | |
| Volume | | | | |
| Percentage of | | | | |
| Droplets with | | | | |
| Diameter of ≦105 μm | | | | |
| Decrease in | 0.0 | 0.0 | 6.5 | 7.1 |
| Cumulative | | | | |
| Volume | | | | |
| Percentage of | | | | |
| Droplets with | | | | |
| Diameter of ≦122 μm | | | | |
| Decrease in | 0.0 | 0.0 | 9.6 | 8.8 |
| Cumulative | | | | |
| Volume | | | | |
| Percentage of | | | | |
| Droplets with | | | | |
| Diameter of ≦141 μm | | | | |
| Decrease in | 0.0 | 0.0 | 9.9 | 8.9 |
| Cumulative | | | | |
| Volume | | | | |
| Percentage of | | | | |
| Droplets with | | | | |
| Diameter of ≦164 μm | | | | |
| Decrease in | 0.0 | 0.0 | 9.8 | 9.6 |
| Cumulative | | | | |
| Volume | | | | |
| Percentage of | | | | |
| Droplets with | | | | |
| Diameter of ≦191 μm | | | | |
| Decrease in | 0.0 | 0.0 | 9.9 | 10.8 |
| Cumulative | | | | |
| Volume | | | | |
| Percentage of | | | | |
| Droplets with | | | | |
| Diameter of ≦220 μm | | | | |
| Component | Composition 3 | Composition 4 | Composition 5 | Composition 6 |
| Pesticide | 5 | 5 | 5 | 5 |
| Concentration | | | | |
| Concentration | 0.9 | 1 | 0.8 | 0.9 |
| of Thickener | | | | |
| Component 1 | | | | |
| Concentration | 0 | 0 | 0 | 0 |
| of Thickener | | | | |
| Component 2 | | | | |
| Number of | 6 | 6 | 6 | 6 |
| Recirculations | | | | |
| Through Pump | | | | |
| Surfactant 1 | 0.9 | 1 | 0.8 | 0.9 |
| Nozzle Type | D6-45 | D6-45 | 8003 | 8003 |
| Volume Median | 324 | 333 | 267.3 | 305.3 |
| Diameter of | | | | |
| Droplets (μm) | | | | |
| Volume | 11.9 | 5.8 | 15.8 | 12.7 |
| Percentage of | | | | |
| Droplets With | | | | |
| Diameters Less | | | | |
| Than 141 μm | | | | |
| Decrease in | 20 | 75 | −4.3 | 22.9 |
| Cumulative | | | | |
| Volume | | | | |
| Percentage of | | | | |
| Droplets with | | | | |
| Diameter of ≦105 μm | | | | |
| Decrease in | 21.6 | 71.3 | −5.4 | 19.1 |
| Cumulative | | | | |
| Volume | | | | |
| Percentage of | | | | |
| Droplets with | | | | |
| Diameter of ≦122 μm | | | | |
| Decrease in | 19.8 | 61.3 | −5.8 | 15.2 |
| Cumulative | | | | |
| Volume | | | | |
| Percentage of | | | | |
| Droplets with | | | | |
| Diameter of ≦141 μm | | | | |
| Decrease in | 16.9 | 49.1 | −4.7 | 13.2 |
| Cumulative | | | | |
| Volume | | | | |
| Percentage of | | | | |
| Droplets with | | | | |
| Diameter of ≦164 μm | | | | |
| Decrease in | 16.4 | 42.1 | −2.5 | 14.3 |
| Cumulative | | | | |
| Volume | | | | |
| Percentage of | | | | |
| Droplets with | | | | |
| Diameter of ≦191 μm | | | | |
| Decrease in | 16.8 | 37.9 | −1.3 | 16.2 |
| Cumulative | | | | |
| Volume | | | | |
| Percentage of | | | | |
| Droplets with | | | | |
| Diameter of ≦220 μm | | | | |
| | | | | Composition |
| Component | Composition 7 | Composition 8 | Composition 9 | 10 |
| Pesticide | 5 | 5 | 5 | 5 |
| Concentration | | | | |
| Concentration | 1 | 0 | 0 | 0 |
| of Thickener | | | | |
| Component 1 | | | | |
| Concentration | 0 | 1 | 1 | 1.23 |
| of Thickener | | | | |
| Component 2 | | | | |
| Number of | 6 | 6 | 6 | 6 |
| Recirculations | | | | |
| Through Pump | | | | |
| Surfactant 1 | 1 | 1 | 1 | 1.23 |
| Nozzle Type | 8003 | D6-45 | D6-45 | D6-45 |
| Volume Median | 299.3 | 337.3 | 335 | 273.7 |
| Diameter (μm) | | | | |
| Volume | 9.7 | 11.2 | 11.4 | 14.6 |
| Percentage of | | | | |
| Droplets With | | | | |
| Diameters Less | | | | |
| Than 141 μm | | | | |
| Decrease in | 58.1 | 28.4 | 27.4 | 25.2 |
| Cumulative | | | | |
| Volume | | | | |
| Percentage of | | | | |
| Droplets with | | | | |
| Diameter of ≦105 μm | | | | |
| Decrease in | 46 | 27.9 | 26.2 | 13.1 |
| Cumulative | | | | |
| Volume | | | | |
| Percentage of | | | | |
| Droplets with | | | | |
| Diameter of ≦122 μm | | | | |
| Decrease in | 35.4 | 25 | 23.3 | 2.4 |
| Cumulative | | | | |
| Volume | | | | |
| Percentage of | | | | |
| Droplets with | | | | |
| Diameter of ≦141 μm | | | | |
| Decrease in | 28.5 | 22.3 | 20.9 | −5.3 |
| Cumulative | | | | |
| Volume | | | | |
| Percentage of | | | | |
| Droplets with | | | | |
| Diameter of ≦164 μm | | | | |
| Decrease in | 27 | 22.5 | 21.5 | −8 |
| Cumulative | | | | |
| Volume | | | | |
| Percentage of | | | | |
| Droplets with | | | | |
| Diameter of ≦191 μm | | | | |
| Decrease in | 25.6 | 23.6 | 22.6 | −8 |
| Cumulative | | | | |
| Volume | | | | |
| Percentage of | | | | |
| Droplets with | | | | |
| Diameter of ≦220 μm | | | | |
| | Composition | Composition | Composition | Composition |
| Component | 11 | 12 | 13 | 14 |
| Pesticide | 5 | 5 | 5 | 5 |
| Concentration | | | | |
| Concentration | 0 | 0 | 0 | 0 |
| of Thickener | | | | |
| Component 1 | | | | |
| Concentration | 1.43 | 1 | 1.23 | 1.43 |
| of Thickener | | | | |
| Component 2 | | | | |
| Number of | 6 | 6 | 6 | 6 |
| Recirculations | | | | |
| Through Pump | | | | |
| Surfactant 1 | 1.43 | 1 | 1.23 | 1.43 |
| Nozzle Type | D6-45 | 8003 | 8003 | 8003 |
| Volume Median | 303.7 | 286 | 334.7 | 413.3 |
| Diameter (μm) | | | | |
| Volume | 13.3 | 14.6 | 12 | 8.4 |
| Percentage of | | | | |
| Droplets With | | | | |
| Diameters Less | | | | |
| Than 141 μm | | | | |
| Decrease in | 18.7 | 1.5 | 18 | 40.8 |
| Cumulative | | | | |
| Volume | | | | |
| Percentage of | | | | |
| Droplets with | | | | |
| Diameter of ≦105 μm | | | | |
| Decrease in | 15.9 | 3.1 | 20.4 | 43.8 |
| Cumulative | | | | |
| Volume | | | | |
| Percentage of | | | | |
| Droplets with | | | | |
| Diameter of ≦122 μm | | | | |
| Decrease in | 10.6 | 2.3 | 19.5 | 43.5 |
| Cumulative | | | | |
| Volume | | | | |
| Percentage of | | | | |
| Droplets with | | | | |
| Diameter of ≦141 μm | | | | |
| Decrease in | 6.2 | 1.8 | 18.8 | 42.7 |
| Cumulative | | | | |
| Volume | | | | |
| Percentage of | | | | |
| Droplets with | | | | |
| Diameter of ≦164 μm | | | | |
| Decrease in | 6.6 | 4.3 | 21.1 | 44.1 |
| Cumulative | | | | |
| Volume | | | | |
| Percentage of | | | | |
| Droplets with | | | | |
| Diameter of ≦191 μm | | | | |
| Decrease in | 8.6 | 7.1 | 24.2 | 45.6 |
| Cumulative | | | | |
| Volume | | | | |
| Percentage of | | | | |
| Droplets with | | | | |
| Diameter of ≦220 μm | | | | |

The Pesticide is Roundup® Original pesticide, commercially available from Monsanto Company of St. Louis, Mo.

The Thickener Component 1 is the thickener component of the present invention and includes an 87/13 ratio of ethylene oxide to propylene oxide as the alkylene oxide, 1,1,1-trimethylolpropane as the compound having at least two reactive hydrogen atoms, and Vikolox® 16 having 16 carbons as the alkyl epoxide, commercially available from Atofina Corporation.

The Thickener Component 2 is also the thickener component of the present invention and includes an 87/13 ratio of ethylene oxide to propylene oxide as the alkylene oxide, 1,1,1-trimethylolpropane as the compound having at least two reactive hydrogen atoms, and Vikolox® 18 having 18 carbons as the alkyl epoxide such that the ratio of the alkyl epoxide to the polyol is 1.5:1, commercially available from Atofina Corporation.

The Pump is a pump known in the art and commercially available from Johnson Pump AB of Orego, Sweden, under the trade name of the Tri-lobe Rotary Lobe Pump.

The Surfactant 1 is an alkylphenol ethoxylate surfactant commercially available from BASF Corporation, under the trade name of Iconol® 35-8.

The Nozzle Type includes a D6-45 disc core nozzle and an 8003 fan nozzle, both known in the art.

As shown in Table 1, the Volume Median Diameter of the droplets of the Compositions 1 through 14 generally increases relative to the Volume Median Diameter of the droplets of the Comparative Compositions 1 and 2. Table 1 also shows that with increasing concentration of the thickener component, a volume percentage of the droplets from the Compositions 1 through 14 with a diameter of less than 141 μm decreases compared to the volume percentage of the droplets from the Comparative Compositions 1 and 2. Table 1 further shows that the decrease in the cumulative volume percentage of the droplets with less than 105, 122, 141, 164, 191, and 220 μm, respectively, generally is greater with increasing concentrations of the thickener component. That is, there are fewer of the droplets with smaller diameters with the thickener component of the present invention in Compositions 1 through 14 than with the Comparative Compositions 1 and 2.

Thus, the results of the droplet size study generally indicate that the pesticide composition of the present invention includes droplets with larger average diameters than the Comparative Compositions 1 and 2, when sprayed. Without intending to be bound by any particular theory, it is believed that the larger average diameters of the droplets contribute to reducing a tendency of the pesticide composition to be subject to wind-drift, allowing the pesticide composition to effectively reach the target.

A second series of pesticide compositions, Compositions 15 through 18, are also formulated according to the present invention. A third comparative pesticide composition, Comparative Composition 3, is also formulated and does not include the pesticide composition of the present invention. Both the Compositions 15 through 18 and the Comparative Composition 3 include sodium fluorescein, a fluorescent dye, whose intensity can be measured to determine retention. Accordingly, a retention study is conducted to measure a level of retention of the Compositions 15 through 18 and the Comparative Composition 3 produced by spraying the Compositions 15 through 18 and the Comparative Composition 3 through a Lechter injector nozzle, ID 120 02 at a pressure of 3 bars and a speed of 1.3 meters per second. The Compositions 15 through 18 and the Comparative Composition 3 are sprayed onto leaves of wheat plants and the level of retention of the pesticide composition on the leaves is determined after 24 hours. The retention is determined quantitatively in counts with a Bethold LB 970 Fluorometer commercially available from Bethold Technologies GmbH & Co., KG, through measurement of an amount of the fluorescent dye extracted from the leaves of the wheat plants after 24 hours. The retention and the measured counts of the Compositions 15 through 18 are greater than the retention and the measured counts of the Comparative Composition 3. Thus, the results of the retention study indicate that the retention of the Compositions 15 through 18 reduces a possibility that the pesticide composition will run off of the target and increases an efficacy of the pesticide composition. The results of the retention study are set forth in Table 2 which shows an increase in retention for the Compositions 15 through 18 as compared to the Comparative Composition 3. Without intending to be bound by any particular theory, it is believed that the increased retention is the result of pseudoplastic properties of the thickener component of the present invention.

Specifically, each of the Compositions 15 through 18 and the Comparative Composition 3 are formulated by adding 5 parts by weight of the pesticide to 100 parts by weight of tap water in a series of containers. The fluorescent dye is also added such that 200 parts of the fluorescent dye are added to 1 million parts of the pesticide and tap water combined. The fluorescent dye is commercially available from Merck (Schweiz) AG, under the trade name of sodium fluorescein. The containers are fluidly connected to either the flat fan nozzle or the disc-core nozzle, and to a source of pressurized air used to displace the Compositions 15 through 18 and the Comparative Composition 3 through the nozzles. Additionally, for each of the Compositions 15 through 18, varying amounts of the thickener component of the present invention are added. The results of the retention study are set forth in Table 2 wherein all components are in parts per one hundred parts water unless otherwise noted.

TABLE 2

| | Comparative | Composition | Composition |
|---|---|---|---|
| Component | Composition 3 | 15 | 16 |
| Pesticide | 5 | 5 | 5 |
| Concentration | | | |
| Concentration | 0 | 0.33 | 0.83 |
| of Thickener | | | |
| Component 1 | | | |
| Concentration | 0 | 0 | 0 |
| of Thickener | | | |
| Component 2 | | | |
| Additive | 0 | 0.333 | 0.833 |
| Surfactant 2 | 0 | 0.333 | 0.833 |
| Defoamer | 0.1 | 0.1 | 0.1 |
| Dye (ppm) | 200 | 200 | 200 |
| Measurement | 24 | 24 | 24 |
| Time (hrs) | | | |
| Average Counts | 117998 | 171348 | 216081 |
| Counts | 100 | 145 | 183 |
| Normalized to | | | |
| Comparative | | | |
| Composition 3 | | | |
| Percentage | 0 | 45 | 83 |
| Increase in Dye | | | |
| Retention | | | |

| | Composition | Composition |
|---|---|---|
| Component | 17 | 18 |
| Pesticide | 5 | 5 |
| Concentration | | |
| Concentration of | 1.25 | 0 |
| Thickener | | |
| Component 1 | | |
| Concentration of | 0 | 0.867 |
| Thickener | | |
| Component 2 | | |
| Additive | 1.25 | 0.867 |
| Surfactant 2 | 1.25 | 0.867 |
| Defoamer | 0.1 | 0.1 |
| Dye (ppm) | 200 | 200 |
| Measurement | 24 | 24 |
| Time (hrs) | | |
| Average Counts | 195957 | 176979 |
| Counts | 166 | 150 |
| Normalized to | | |
| Comparative | | |
| Composition 3 | | |
| Percentage | 66 | 50 |
| Increase in Dye | | |
| Retention | | |

The Pesticide, Thickener Component 1, and Thickener Component 2, set forth in Table 2, are the same as the Pesticide, Thickener Component 1, and Thickener Component 2, set forth in Table 1.

The Additive is propylene glycol.

The Surfactant 2 is a fatty alcohol ethoxylate surfactant commercially available from BASF Aktiengesellschaft of Ludwigshafen, Germany, under the trade name of Lutensol® AO 8.

The Defoamer is a silicone defoamer commercially available from Dow AgroSciences LLC of Indianapolis, Ind., and Wacker-Chemie GmbH of Munich, Germany, under the trade name of Schaumstopp.

The Dye is sodium fluorescein, commercially available from Merck (Schweiz) AG.

A third series of pesticide compositions, Compositions 19 through 37, are also formulated according to the present invention. A fourth comparative pesticide composition, Comparative Composition 4, is also formulated and does not include the pesticide composition of the present invention. An evaluation of viscosity is conducted to measure viscosities of the Compositions 19 through 37 including differing amounts of the thickener component. The viscosities of the Compositions 19 through 37 and Comparative Composition 4 are measured according to ASTM D-445 using a Brookfield Model RVTDV II viscometer commercially available from Brookfield Engineering of Middleboro, Mass. both with and without Cannon-Fenske viscosity tubes commercially available from Cannon Instrument Company of State College, Pa. The viscosities are set forth in Table 3 which shows an increased viscosity of the Compositions 19 through 37 as compared to the viscosity of the Comparative Composition 4. Without intending to be bound by any particular theory, it is believed that the increased viscosity is due to an interaction of the thickener component and other hydrophobic components of the pesticide composition.

Specifically, each of the Compositions 19 through 37 and the Comparative Composition 4 are formulated by adding 5 parts by weight of the pesticide to 100 parts by weight of tap water. Additionally, varying amounts of the thickener component are individually added to the Compositions 19 through 37, but are not added to the Comparative Composition 4. The results of the evaluation of the viscosities are set forth in Table 3 wherein all components are in parts per one hundred parts water unless otherwise noted.

TABLE 3

| | Comparative | | | |
|---|---|---|---|---|
| | Composition | Composition | Composition | Composition |
| Component | 4 | 19 | 20 | 21 |
| Pesticide | 5 | 5 | 5 | 5 |
| Concentration | | | | |
| Concentration | 0 | 0.43 | 0.90 | 1 |
| of Thickener | | | | |
| Component 1 | | | | |
| Concentration | 0 | 0 | 0 | 0 |
| of Thickener | | | | |
| Component 2 | | | | |
| Surfactant 1 | 0 | 0.43 | 0.90 | 1 |
| Additive | 0 | 0.43 | 0.90 | 1 |
| Viscosity with | 1.28 | 2.56 | 7.04 | 9.6 |
| Brookfield (cP) | | | | |
| Viscosity with | 0.995 | 1.52 | 6.56 | 9.22 |
| Cannon-Fenske | | | | |
| (cP) | | | | |
| | Composition | Composition | Composition | Composition |
| Component | 22 | 23 | 24 | 25 |
| Pesticide | 5 | 5 | 5 | 5 |
| Concentration | | | | |
| Concentration | 1.1 | 1.2 | 1.32 | 1.4 |
| of Thickener | | | | |
| Component 1 | | | | |
| Concentration | 0 | 0 | 0 | 0 |
| of Thickener | | | | |
| Component 2 | | | | |
| Surfactant 1 | 1.1 | 1.2 | 1.32 | 1.4 |
| Additive | 1.1 | 1.2 | 1.32 | 1.4 |
| Viscosity with | 15.4 | 23.6 | 35.8 | 53.2 |
| Brookfield (cP) | | | | |
| Viscosity with | 15.5 | 24.2 | 39.1 | 55.9 |
| Cannon-Fenske | | | | |
| (cP) | | | | |
| | Composition | Composition | Composition | Composition |
| Component | 26 | 27 | 28 | 29 |
| Pesticide | 5 | 5 | 5 | 5 |
| Concentration | | | | |
| Concentration | 1.5 | 2 | 0 | 0 |
| of Thickener | | | | |
| Component 1 | | | | |
| Concentration | 0 | 0 | 0.41 | 0.51 |
| of Thickener | | | | |
| Component 2 | | | | |
| Surfactant 1 | 1.5 | 2 | 0.41 | 0.51 |
| Additive | 1.5 | 2 | 0.41 | 0.51 |
| Viscosity with | 71.6 | 322 | 2.56 | 3.2 |
| Brookfield (cP) | | | | |
| Viscosity with | 80.2 | 352 | 1.58 | 2.07 |
| Cannon-Fenske | | | | |
| (cP) | | | | |
| | Composition | Composition | Composition | Composition |
| Component | 30 | 31 | 32 | 33 |
| Pesticide | 5 | 5 | 5 | 5 |
| Concentration | | | | |
| Concentration | 0 | 0 | 0 | 0 |
| of Thickener | | | | |
| Component 1 | | | | |
| Concentration | 0.62 | 0.72 | 0.81 | 0.9 |
| of Thickener | | | | |
| Component 2 | | | | |
| Surfactant 1 | 0.62 | 0.72 | 0.81 | 0.9 |
| Additive | 0.62 | 0.72 | 0.81 | 0.9 |
| Viscosity with | 4.48 | 8.32 | 18.6 | 35.2 |
| Brookfield (cP) | | | | |
| Viscosity with | 3.47 | 7.15 | 18.7 | 42.7 |
| Cannon-Fenske | | | | |
| (cP) | | | | |
| | Composition | Composition | Composition | Composition |
| Component | 34 | 35 | 36 | 37 |
| Pesticide | 5 | 5 | 5 | 5 |
| Concentration | | | | |
| Concentration | 0 | 0 | 0 | 0 |
| of Thickener | | | | |
| Component 1 | | | | |
| Concentration | 0.97 | 1.02 | 1.11 | 1.19 |
| of Thickener | | | | |
| Component 2 | | | | |
| Surfactant 1 | 0.97 | 1.02 | 1.11 | 1.19 |
| Additive | 0.97 | 1.02 | 1.11 | 1.19 |
| Viscosity with | 57 | 117 | 308 | 484 |
| Brookfield (cP) | | | | |
| Viscosity with | 68.5 | 130 | 308 | 525 |
| Cannon-Fenske | | | | |
| (cP) | | | | |

The Pesticide, Thickener Component 1, Thickener Component 2, and Surfactant 1 set forth in Table 3, are the same as the Pesticide, Thickener Component 1, Thickener Component 2, and Surfactant 1, set forth in Table 1. Also, the Additive set forth in Table 3 is the same as the Additive set forth in Table 2.

As shown in Table 3, the viscosities of the Compositions 19 through 37 increase with increasing amounts of the thickener component. It is believed that the increasing viscosities of the Compositions 19 through 37 contribute to the increased retention of the pesticide composition.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A pesticide composition comprising:
A. an agricultural pesticide component; and
B. a thickener component having a terminal group formed from an alkyl epoxide having at least 5 carbon atoms.

2. A pesticide composition as set forth in claim 1 wherein said thickener component comprises the reaction product of:
(i) an alkylene oxide;
(ii) a compound having at least two active hydrogen atoms; and
(iii) said alkyl epoxide.

3. A pesticide composition as set forth in claim 2 wherein said compound is selected from the group of glycerol, 1,1,1-trimethylolpropane, and combinations thereof.

4. A pesticide composition as set forth in claim 3 wherein said alkylene oxide is selected from the group of ethylene oxide, propylene oxide, butylene oxide, amylene oxide, and combinations thereof.

5. A pesticide composition as set forth in claim 1 wherein said alkyl epoxide has from 8 to 28 carbon atoms.

6. A pesticide composition as set forth in claim 5 wherein said alkyl epoxide has from 16 to 18 carbons atoms.

7. A pesticide composition as set forth in claim 1 wherein said thickener component comprises the reaction product of:
(i) an alkylene oxide;
(ii) a compound having at least two active hydrogen atoms;
(iii) said alkyl epoxide; and
(iv) a second alkyl epoxide having at least 5 carbon atoms.

8. A pesticide composition as set forth in claim 7 wherein said second alkyl epoxide has from 8 to 28 carbon atoms.

9. A pesticide composition as set forth in claim 8 wherein said second alkyl epoxide has from 16 to 18 carbons atoms.

10. A pesticide composition as set forth in claim 1 wherein said thickener component has a molecular weight from 1,000 to 40,000 g/mol.

11. A pesticide composition as set forth in claim 1 wherein said thickener component is present in said pesticide composition in an amount from 0.1 to 8 parts by weight per 100 parts by weight of said pesticide composition.

12. A pesticide composition as set forth in claim 1 further comprising a surfactant.

13. A pesticide composition as set forth in claim 1 wherein said agricultural pesticide component is selected from the group of acaricides, avicides, algicides, biocides, fungicides, herbicides, insecticides, miticides, molluscicides, nematicides, ovicides, rodenticides, virucides, and combinations thereof.

14. A pesticide composition as set forth in claim 1 wherein said agricultural pesticide component comprises an herbicide.

15. A pesticide composition as set forth in claim 1 further comprising water wherein said agricultural pesticide component is present in said pesticide composition in an amount from 1 to 10 parts by weight per 100 parts by weight of said water.

16. A pesticide composition as set forth in claim 1 wherein said agricultural pesticide component is present in said pesticide composition in an amount from 3 to 7 parts by weight per 100 parts by weight of said pesticide composition.

17. A pesticide composition as set forth in claim 1 further comprising an additive selected from the group of a water soluble amine, water, alcohol, and combinations thereof.

18. A pesticide composition as set forth in claim 17 wherein said alcohol comprises propylene glycol.

19. A pesticide composition as set forth in claim 1 having a shear viscosity of at least 15 cP at a temperature at 77° F.

20. A pesticide composition as set forth in claim 1 wherein, upon spraying, said pesticide composition forms droplets having a diameter of from 100 to 1,400 micrometers.

21. A pesticide composition as set forth in claim 1 further comprising water and wherein said agricultural pesticide component comprises an herbicide present in said pesticide composition in an amount of from 1 to 10 parts by weight per 100 parts by weight of said water and said thickener component comprises the reaction product of:
(i) an alkylene oxide;
(ii) a compound having at least two active hydrogen atoms; and
(iii) said alkyl epoxide.

22. A pesticide composition as set forth in claim 21 wherein said alkylene oxide comprises a combination of ethylene oxide and propylene oxide, said compound comprises 1,1,1-trimethylolpropane, said alkyl epoxide has of from 16 to 18 carbon atoms, and said pesticide composition further comprises a surfactant and propylene glycol.

23. A pesticide composition as set forth in claim 1 that is applied to plants.

24. A pesticide composition comprising:
A. an agricultural pesticide component selected from the group of fungicides, herbicides, insecticides, and combinations thereof; and
B. a thickener component having a terminal group formed from an alkyl epoxide having at least 5 carbon atoms.

25. A pesticide composition as set forth in claim 24 wherein said thickener component comprises the reaction product of:
(i) an alkylene oxide;
(ii) a compound having at least two active hydrogen atoms; and
(iii) said alkyl epoxide.

26. A pesticide composition as set forth in claim 24 wherein said alkyl epoxide has from 8 to 28 carbon atoms.

27. A pesticide composition as set forth in claim 26 wherein said alkyl epoxide has from 16 to 18 carbons atoms.

28. A pesticide composition as set forth in claim 24 wherein said thickener component comprises the reaction product of:
(i) an alkylene oxide;
(ii) a compound having at least two active hydrogen atoms;
(iii) said alkyl epoxide; and
(iv) a second alkyl epoxide having at least 5 carbon atoms.

29. A pesticide composition as set forth in claim 24 wherein said agricultural pesticide component is present in said pesticide composition in an amount from 3 to 7 parts by weight per 100 parts by weight of said pesticide composition.

30. A pesticide composition as set forth in claim 24 wherein said thickener component is present in said pesticide composition in an amount from 0.1 to 8 parts by weight per 100 parts by weight of said pesticide composition.

31. A pesticide composition as set forth in claim 24 having a shear viscosity of at least 15 cP at a temperature at 77° F.

32. A pesticide composition as set forth in claim 24 wherein, upon spraying, said pesticide composition forms droplets having a diameter of from 100 to 1,400 micrometers.

33. A pesticide composition as set forth in claim 24 wherein said agricultural pesticide component comprises an insecticide.

34. A pesticide composition as set forth in claim 24 wherein said agricultural pesticide component comprises a fungicide.

35. A pesticide composition as set forth in claim 24 that is applied to plants.

36. A pesticide composition comprising:
A. a pesticide component comprising an herbicide; and
B. a thickener component having a terminal group formed from an alkyl epoxide having at least 5 carbon atoms.
